(19) United States
(12) Patent Application Publication
(10) Pub. No.: US 2011/0143138 A1
(43) Pub. Date: Jun. 16, 2011

(54) PERFLUOROELASTOMER BONDING

(75) Inventors: Robert E. Eggers, Arden Hills, MN (US); Naiyong Jing, Woodbury, MN (US); Jason L. Krengel, Good Thunder, MN (US); Werner M.A. Grootaert, Oakdale, MN (US)

(73) Assignee: 3M Properties Company

(21) Appl. No.: 12/634,846

(22) Filed: Dec. 10, 2009

(51) Int. Cl. B32B 27/04; C09D 163/00; B05D 3/10

(52) U.S. Cl. 428/392; 523/400; 427/340; 428/414

(57) ABSTRACT

There is provided a primer composition having a curative, a solvent, and an epoxide resin; wherein the curative is capable of reacting the epoxide resin; and further wherein; (a) the curative is capable of curing a perfluoroelastomer compound having at least one cure site and a crosslinking agent or catalyst; or (b) when the curative is not capable of curing the perfluoroelastomer compound, the perfluoroelastomer comprises a crosslinking agent or catalyst capable of curing the epoxide resin. The primer composition according to the present disclosure are used to bond perfluoroelastomer compounds to substrates. Methods of bonding a perfluoroelastomer compound to a substrate and multilayered articles comprising a perfluoroelastomer, a primer layer, and a substrate are also provided.

The present disclosure relates to primer compositions and methods of bonding perfluoroelastomer compositions to substrates during the crosslinking process.

### SUMMARY

In one aspect, the present disclosure provides a primer composition comprising a curative, a solvent and an epoxide resin, wherein the curative is capable of reacting the epoxide resin; and further wherein; (a) the curative is capable of curing a perfluoroelastomer compound having at least one cure site and a crosslinking agent or catalyst; or (b) when the curative is not capable of curing the perfluoroelastomer compound, the perfluoroelastomer comprises a crosslinking agent or catalyst capable of curing the epoxide resin.

In another aspect, the present disclosure provides a process of bonding a perfluoroelastomer compound to a substrate comprising: (a) coating the substrate with a primer composition comprising a curative, a solvent, and an epoxide resin; wherein the curative is capable of curing the epoxide resin; and further wherein; (i) the curative is capable of curing the perfluoroelastomer compound having at least one cure site and a crosslinking agent or catalyst; or (ii) when the curative is not capable of curing the perfluoroelastomer compound, the perfluoroelastomer comprises a crosslinking agent or catalyst capable of curing the epoxide resin; (b) covering the coated substrate with the perfluoroelastomer compound; and (c) heating the perfluroelastomer compound covered substrate to at least 150° C. to form a cured and bonded perfluoroelastomer article.

In yet another aspect, the present disclosure provides a multilayer article comprising a substrate, a primer layer and a curable perfluoroelastomer layer; wherein the primer layer is derived from a composition comprising a curative, a solvent and an epoxide resin; wherein the curative is capable of curing the epoxide resin; and further wherein; (a) the curative is capable of curing a perfluoroelastomer compound having at least one cure site and a crosslinking agent or catalyst; or (b) when the curative is not capable of curing the perfluoroelastomer compound, the perfluoroelastomer comprises a crosslinking agent or catalyst capable of curing the epoxide resin.

The above summary of the present disclosure is not intended to describe each embodiment of the present invention. The details of one or more embodiments of the invention are also set forth in the description below. Other features, objects, and advantages of the invention will be apparent from the description and from the claims.

### DETAILED DESCRIPTION

The term “epoxide resin” as used herein means interpolymerized epoxy monomers and/or epoxy oligomers. The term “epoxy resin” as used herein means the epoxide resin and a curing agent.

The term “perfluoro” or “perfluorinated” as used herein means that the respective compound has all hydrogen atoms replaced by fluorine atoms without however excluding the possibility that some of the hydrogen atoms have been replaced with chlorine, bromine or iodine atoms. Specifically, the term “perfluoropolymer” is intended to mean a fluoropolymer that has a perfluorinated backbone, i.e. a backbone in which the hydrogen atoms are replaced with fluorine atoms without excluding polymers wherein some of the hydrogen atoms have been replaced with a halogen other than fluorine, such as for example chlorine as may be the case if the fluoropolymer derives from a polymerization involving chlorotrifluoroethylene.

Polymers of this disclosure comprise perfluoroelastomers gums and cured perfluoroelastomers. A perfluoroelastomer is a perfluorinated rubber of the polymethylene type having all fluoro, perfluoroalkyl, or perfluoroalkoxy substituent groups on the polymer chain; a small fraction of these groups may contain functionality to facilitate crosslinking As used herein, the terms “perfluoroelastomer”, “perfluoroelastomer compositions” and “perfluoroelastomer gum” are used interchangeably and refer to amorphous perfluorocarbon polymers that are capable of being crosslinked, thereby generating perfluorocarbon elastomers. Crosslinked perfluoroelastomer gums are interchangeably referred to herein as “cured perfluoroelastomers”.

The term “perfluoroelastomer compound” as used herein means a compounded mixture comprising the perfluoroelastomer gum and any additives or processing aids typically utilized in fluoropolymer compounding. Such additives include those known in the art. Exemplary additives include: stabilizers, plasticizers, pigments, lubricants, and fillers (such as fluoropolymer fillers, carbon black, calcium carbonate, and silicon dioxide (silica)), and acid acceptors (such as zinc oxide, calcium hydroxide, and magnesium oxide).

Perfluoroelastomers are perfluoropolymers that are resistant to high temperature, plasma and chemical environments. Perfluoroelastomer compositions are useful as sealing materials in applications in which elevated temperature, plasma or aggressive chemical environments are encountered. Some of these applications include o-rings, flange seals, packings, gaskets, pump diaphragms, plunger seals, door seals, lip and face seals, gas delivery plate seals, wafer support seals, barrel seals, and the like. These applications are found in a variety of industries such as chemical processing, semiconductor, aerospace, automotive, petroleum, and the like.

For many of these applications it is desirable to bond the perfluoroelastomer compositions to other substrates during the crosslinking or molding process, resulting in a composite article. Because of the chemical inertness of perfluoroelastomers, obtaining strong bonding between perfluoroelastomer compositions and other substrates has been challenging. It is particularly challenging to obtain strong bonding between perfluoroelastomer compositions and other substrates when subjected to elevated temperatures, such as for example temperatures above 200° C.

There are known methods of bonding fluoroelastomers and perfluoroelastomers to substrates during crosslinking While some of these methods provide some measure of adhesion between perfluoroelastomer compositions and substrates, there still exists a need for improved bonding between perfluoroelastomer compositions and substrates.

The present disclosure provides surprisingly strong bonding between a perfluoroelastomer composition and a substrate that is coated with the primer composition of the present disclosure.

A primer is a coating that is applied to a substrate to prepare the surface of the substrate for subsequent modification, for example, addition layers. The primer composition of the present disclosure comprises an epoxide resin, a curative, and a solvent.

Epoxide resins useful in the present disclosure are any organic compounds having at least one oxirane ring, that is,

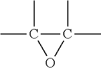

polymerizable by a ring opening reaction. Such materials, broadly called epoxides, include both monomeric and polymeric epoxides and can be aliphatic, heterocyclic, cycloaliphatic, aromatic, and combinations thereof. They can be a liquid, a solid, or blends thereof, blends being useful in providing tacky mixtures prior to cure. These epoxide resins generally have, on the average, a functionality greater than two, i.e., at least two epoxy groups per molecule and are also called “polyepoxides.” The polymeric epoxides include linear polymers having terminal epoxy groups (for example, a diglycidyl ether of a polyoxyalkylene glycol), polymers having skeletal oxirane units (for example, polybutadiene polyepoxide), and polymers having pendent epoxy groups (for example, a glycidyl methacrylate polymer or copolymer). The molecular weight of the epoxide resin may be at least 75, 100, 500, 1000, 2000, 4000, or even 5000 grams/mole; at most 4000, 6000, 8000, 100000, or even 15000 grams/mole. In one embodiment the molecular weight of the epoxide resin is more than 100,000 grams/mole.

Useful epoxide resins include those which contain cyclohexene oxide groups such as the epoxycyclohexane carboxylates, typified by 3,4-epoxycyclohexylmethyl-3,4-epoxycyclohexane carboxylate, 3,4-epoxy-2-methylcyclohexylmethyl-3,4-epoxy-2-methycyclohexane carboxylate, and bis(3,4-epoxy-6-methylcyclohexylmethyl)adipate. For a more detailed list of useful epoxides of this nature, reference may be made to U.S. Pat. No. 3,117,099.

Further epoxide resins which are particularly useful in the practice of this invention include glycidyl ether monomers of the formula:

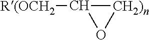

where R′ is aliphatic, for example, alkyl; aromatic, for example, aryl; or combinations thereof, and n is an integer of 1 to 6. Examples are the glycidyl ethers of polyhydric phenols such as the diglycidyl ether of 2,2-bis-(4-hydroxyphenol)propane (Bisphenol A) and copolymers of (chloromethyl)oxirane and 4,4′-(1-methylethylidene)bisphenol. Further examples of epoxides of this type which can be used in the practice of this disclosure are described in U.S. Pat. No. 3,018,262.

There are a host of commercially available epoxide resins that can be used in the present disclosure. In particular, epoxides which are readily available include styrene oxide, vinylcyclohexene oxide, glycidol, glycidyl methacrylate, diglycidyl ether of Bisphenol A (for example, those available under the trade designations “EPON 828”, “EPON 1004F”, and “EPON 1001F” from Hexion Specialty Chemicals, Columbus, Ohio and “DER-332” and “DER-334”, from Dow Chemical Co., Midland, Mich.), diglycidyl ether of Bisphenol F (for example, those under the trade designations “ARALDITE GY281” from Ciba-Geigy Corp. Tarrytown, N.Y., and “EPON 862” from Hexion Specialty Chemicals, vinylcyclohexane dioxide (for example, having the trade designation “ERL-4206” from Union Carbide Corp., Houston, Tex.), 3,4-epoxycyclohexyl-methyl-3,4-epoxycyclohexene carboxylate (for example, having the trade designation “ERL-4221” from Union Carbide Corp.), 2-(3,4-epoxycyclohexyl-5,5-spiro-3,4-epoxy)cyclohexane-metadioxane (for example, having the trade designation “ERL-4234” from Union Carbide Corp.), bis(3,4-epoxycyclohexyl)adipate (for example, having the trade designation “ERL-4299” from Union Carbide Corp.), dipentene dioxide (for example, having the trade designation “ERL-4269” from Union Carbide Corp.), epoxidized polybutadiene (for example, having the trade designation “OXIRON 2001” from FMC Corp., Philadelphia, Pa.), flame retardant epoxide resins (for example, having the trade designation “DER-542”, a brominated bisphenol type epoxide resin available from Dow Chemical Co.), 1,4-butanediol diglycidyl ether (for example, having the trade designation “ARALDITE RD-2” from Ciba-Geigy Corp., now BASF Corp., Florham Park, N.J.), diglycidyl ether of hydrogenated Bisphenol A based epoxide resins (for example, having the trade designation “EPONEX 1510” from Hexion Specialty Chemicals, and polyglycidyl ether of phenol-formaldehyde novolak (for example, having the trade designations “DEN-431” and “DEN-438” from Dow Chemical Co.).

In one embodiment, epoxide resin of the present disclosure exhibit high temperature stability, i.e., does not decompose at temperatures of at least 200° C. Typically, epoxide resins that comprise phenolic moieties have high temperature stability. Polyaromatic epoxide resins are also contemplated in the present disclosure because of their anticipated high temperature stability.

Exemplary epoxide resins include: creosol/Novolak, epichlorohydrin/tetraphenylol ethane, bisphenol A/epichlorohydrin, Novolak/bisphenol A, epichlorohydrin/phenol-formaldehyde, 9,9bis-2,3 epoxypropylphenyl fluorene, bisphenol AF/epichlorohydrin, Novolak/bisphenol AF, and combinations thereof. As used herein the “/” in the epoxide resins denotes a compound comprising both elements. For example bisphenol A/epichlorohydrin is a diglycidyl ether of Bisphenol A.

The curative in the primer composition is a compound that is capable of reacting with the epoxide resin to cure the epoxide resin.

Curatives include, for example, those which are temperature sensitive (e.g., react at room temperature or are heat-activated), are photolytically active, and combinations thereof. Room temperature curatives and heat-activated curatives can include, for example, blends of epoxy homopolymerization type curatives and addition type curatives. The curatives may react at temperatures of at least room temperature, 30° C., 40° C., 50° C., 60° C., 80° C., 100° C., or even 110° C.; at most 50° C., 60° C., 80° C., 100° C., 120° C., 150° C., 180° C., 200° C., 220° C., 250° C., or even 300° C.

Examples of suitable curatives include polybasic acids and their anhydrides, for example, di-, tri- and higher carboxylic acids such as oxalic acid, phthalic acid, terephthalic acid, succinic acid, maleic acid, alkyl and alkenyl substituted succinic acids, tartaric acid, and anhydrides, for example, phthalic anhydride, succinic anhydride, maleic anhydride, nadic anhydride and pyromellitic anhydride; polymerizable unsaturated acids, for example, those containing at least 10 carbon atoms, for example, dodecendioic acid, 10,12-eicosadiendioic acid; and mercaptans.

Examples of other suitable curatives include nitrogen containing compounds, for example, benzyldimethylamine, benzylamine, N,N-diethyl aniline, melamine, pyridine, hydrazides, and aromatic polyamines, such as o-, m-, and p-phenylene diamine, 4,4′-diaminodiphenyl sulfone, 3,3′-diaminodiphenyl sulfone, and 4,4′-diaminodiphenyl sulfide, 4,4′-diaminodiphenyl ketone, 4,4′-diaminodiphenyl ether, 4,4′-diaminodiphenyl methane, 1,3-propanediol-bis(4-aminobenzoate), fluorene-containing amines (for example, 9,9-bis(4-aminophenyl)fluorene, 9,9-bis(3-methyl-4-aminophenyl)fluorene, 9,9-bis(3,5-dimethyl-4-methylaminophenyl)fluorene, 9,9-bis(3,5-dimethyl-4-aminophenyl)fluorene, 9,9-bis(3,5-diisopropyl-4-aminophenyl)fluorene, and 9,9-bis(3-chloro-4-aminophenyl)fluorene); 1,4-bis[α-(4-aminophenyl)-α-methylethyl]benzene, 1,4-bis[α-(4-amino-3,5-dimethylphenyl)-α-methylethyl]benzene, bis(4-amino-3-methylphenyl)sulfone, 1,1′-biphenyl-3,3′-dimethyl-4,4′-diamine, 1,1′-biphenyl-3,3′-dimethoxy-4,4′-diamine, 4,7,10-trioxatridecane-1,13-diamine, and diaminonaphthalenes.

Examples of other suitable aliphatic nitrogen-containing curatives include poly(ether)amines, guanidines (for example, dicyandiamide and tetramethyl guanidine), imidazoles (for example, 2-ethyl-4-methyl imidazole), cyclohexylamine, diethylenetriamine, triethylenetetraamine, cyclohexyldiamine, tetramethylpiperamine, N,N-dibutyl-1,3-propane diamine, N,N-diethyl-1,3-propane diamine, 1,2-diamino-2-methyl-propane, 2,3-diamino-2-methylbutane, 2,3-diamino-2-methylpentane, and 2,4-diamino-2,6-dimethyloctane.

Examples of suitable phenolic curatives include polyhydric phenols, for example, pyrocatechol, resorcinol, hydroquinone, 4,4′-dihydroxydiphenyl methane, 4,4′-dihydroxydiphenyl dimethylmethane, 4,4′-dihydroxy-3,3′-dimethyldiphenyl methane, 4,4′-dihydroxydiphenyl methylmethane, 4,4′-dihydroxydiphenyl cyclohexane, 4,4′-dihydroxy-3,3′-dimethyldiphenyl dimethylmethane, 4,4′-dihydroxydiphenyl sulfone, and tris-(4-hydroxyphenyl)methane; and 9,9-bis(4-hydroxyphenyl) fluorene and ortho-substituted analogs thereof.

Other useful curatives include chloro-, bromo-, and fluoro-containing Lewis acids of aluminum, boron, antimony, and titanium, such as aluminum trichloride, aluminum tribromide, boron trifluoride, antimony pentafluoride, titanium tetrafluoride, and the like. It is also desirable at times that these Lewis acids be blocked. Representative of blocked Lewis acids are BF₃-monoethylamine, and the adducts of SbF₅X, in which X is a halogen, —OH, or —OR1 in which R1 is the residue of an aliphatic or aromatic alcohol, aniline, or a derivative thereof, as described in U.S. Pat. No. 4,503,211.

Suitable photolytically activated curatives include, for example, iodonium and sulfonium salts of antimony and cobalt, and bis(arene) iron compounds, and other photogenerated acids or bases.

Examples of commercially available curatives suitable for use in the epoxides include those sold under the trade names “EPI-CURE 8535-W-50” and “EPI-CURE 8537-WY-60” (available from Hexion Specialty Chemicals), HY 955 (available from Ciba Specialty Chemicals Corp.), “AMICURE CG-1400”, “ANCAMINE 2337S”, “CUREZOL 2E4MZ”, and “CUREZOL PHZ-S” (available from Air Products, Pacific Anchor Chemical, Allentown, Pa.), “EPIKURE 3502” (available from Hexion Specialty Chemicals, Columbus, Ohio), and “DCA-221” (available from Dixie Chemical Co., Pasadena, Tex.).

Exemplary curatives include isophthalyl dihydrazide, dicyandiamide, 4,4-aminophenyl disulfide, guanidine carbonate, urea, thiourea, a ketimine comprising a condensation reaction of ethylenediamine or 3-aminopropyl triethoxysilane and methylisobutylketone, anilines (e.g., paramethoxy aniline), o-bis aminophenol AF, and combinations thereof.

The curative may be present in an amount of about 0.01 to 70 percent by weight based on the epoxide resin. When the curative is a carboxylic acid, a guanidine, a phenol, an anhydride, or a primary or secondary amine, the curative may be present in about 0.5 to about 1.7 equivalents of acid, anhydride, or amine per equivalent of epoxide group. When the curative is an anhydride or a phenol, accelerators may be added in amounts of about 0.01 to about 5.0 percent based on the weight of epoxide resin. Accelerators may also be used. Examples of suitable accelerators include aromatic tertiary amines such as benzyldimethyl amine, and imidazoles such as 2-ethyl-4-methylimidazole. Lewis acids may be used in amounts of between about 0.1 and about 5 percent by weight based on the total weight of the epoxide resin.

The epoxide resin and curative are mixed in a suitable solvent. The solvent is selected based on the application requirements for solubility, evaporation rates, flow-out, leveling properties, odor, etc. Preferably, the solvent is capable of dissolving the epoxide resin and, preferably, the curative. In one embodiment, a blend of solvents is used.

Exemplary solvents include: ketones such as acetone, methyl ethyl ketone, methyl isobutyl ketone, methyl isopropyl ketone, and ethyl isopropyl ketone; esters such as ethyl acetate and butyl acetate; alcohols such as methanol and ethanol; sulfones such as dimethyl sulfone; sulfoxides such as dimethyl sulfoxide; glycol ethers such as ethylene glycol monohexyl ether and diethylene glycol monomethyl ether; glycol ether esters such as ethylene glycol monobutyl ether acetate and dipropylene glycol monomethyl ether acetate; dimethylformamide; tetrahydrofuran; fluorinated alcohols such as perfluoro isopropanol and partially fluorinated pentanol; and combinations thereof.

The perfluoroelastomer compound comprises a perfluoroelastomer and a crosslinking agent or catalyst. Perfluoroelastomers useful in the present disclosure exhibit resistance to most chemicals, such as acids, alkalines, fuel, ketones, aldehydes, esters, alcohols and amines. The presently disclosed perfluoroelastomers also exhibit good processability, scorch resistance and de-moldability along with excellent physical properties, such as compression set resistance over a broad temperature range.

Exemplary perfluoroelastomers comprise interpolymerized monomers of tetrafluoroethylene (TFE) and perfluoroalkyl vinyl ethers (e.g. perfluoromethyl vinyl ether).

In order to be curable, perfluoroelastomers of the perfluoroelastomer compound comprise cure sites. These cure sites, in addition to the crosslinking agent or the catalyst are used to crosslink the perfluoroelastomer compound. In some embodiments, the cure site monomers may be nonfluorinated, partially fluorinated (e.g., vinylidene fluoride or pentafluoropropene), or fully fluorinated.

In one embodiment, the curative reacts with both the epoxide resin and the perfluoroelastomer. In this embodiment, the perfluoroelastomer compound comprises at least one cure site and a crosslinking agent or a catalyst.

In another embodiment, the curative is not capable of curing the perfluoroelastomer compound. In this embodiment, the curing agent or the catalyst in the perfluoroelastomer compound reacts with both the epoxide resin and the perfluoroelastomer.

As used herein, a crosslinking agent refers to a molecule that is part of the polymeric crosslink after the crosslinking reaction, whereas a crosslinking catalyst is a molecule, which participates in the crosslinking reaction, but is not part of the resulting polymeric crosslink.

The fluoropolymers of the disclosure may include a cure site component, which enables curing (or crosslinking) of the fluoroelastomer. Exemplary cure sites include a nitrogen, a bromine, a chlorine or an iodine containing cure site, or an olefin. Typically cure site monomers comprising the cure sites are incorporated into the fluoropolymer during polymerization. Examples of monomers comprising nitrogen-containing groups useful in preparing fluoropolymers comprising a nitrogen-containing cure site include free-radically polymerizable nitriles, imidates, amidines, amides, imides, and amine-oxides.

Useful nitrogen containing cure sites include, for example, perfluoro(8-cyano-5-methyl-3,6-dioxa-1-octene); CF₂═CFO(CF₂)_{L}CN wherein L is an integer from 2 to 12; CF₂═CFO(CF₂)ᵤOCF(CF₃)CN wherein u is an integer from 2 to 6; CF₂═CFO[CF₂CF(CF₃)O]_{q}(CF₂O)_{y}CF(CF₃)CN wherein q is an integer from 0 to 4 and r is an integer from 0 to 6; or CF₂═CF[OCF₂CF(CF₃)]ᵣO(CF₂)ₜCN wherein r is 1 or 2, and t is an integer from 1 to 4; and derivatives and combinations of the foregoing.

The perfluoroelastomer must contain a sufficient quantity of nitrogen functional groups that can act as cure sites for crosslinking reactions. In one embodiment, the nitrogen-containing functional group is a nitrile-containing group. Nitrile groups may be introduced by use of a nitrile-containing cure site monomer, i.e., the nitrile groups are introduced into the polymer during polymerization. However, other methods of introduction are also contemplated by this disclosure. Examples of a nitrile-containing cure site monomers include CF₂═CFOCF₂(CF₂)₃CF₂CN; CF₂═CFOCF₂CF(CF₃)OCF₂CF₂CN; or combinations thereof.

The amount of nitrogen-containing cure sites in a side chain position of the fluoropolymer generally is from about 0.05 to about 5 mole percent or even from 0.1 to 2 mole percent.

The fluoroelastomer gums may also contain halogen containing material that is capable of participation in a peroxide cure reaction. Typically the halogen is bromine or iodine. Suitable cure site components include terminally unsaturated monoolefins of 2 to 4 carbon atoms such as bromodifluoroethylene, bromotrifluoroethylene, and iodotrifluoroethylene, 4-iodo-3,3,4,4 tetrafluorobutene-1, and 4-bromo-3,3,4,4-tetrafluorobutene-1. Examples of other suitable cure site components include: CF₂═CFOCF₂CF₂Br, CF₂═CFOCF₂CF₂CF₂Br, and CF₂═CFOCF₂CF₂CF₂OCF₂CF₂Br. Preferably, all or essentially all of these components are ethylenically unsaturated monomers. In some embodiments, the bromine and/or iodine atom may be an endgroup of the fluoroelastomer gum.

Another suitable cure site component useful in the present invention are olefins. For example, pendant vinyl groups derived from fluorinated bisolefins as described in U.S. Pat. No. 5,585,449 (Arcella et al.) and U.S. Pat. No. 5,902,857 (Wlassics et al.).

Crosslinking agents or catalysts are added to the perfluorelasomer gum to crosslink the fluoropolymer. Generally, the effective amount of crosslinking agent or catalyst, which may include more than one composition, is at least about 0.1 parts per hundred parts of the curable composition on a weight basis, more typically at least about 0.5 parts per hundred parts of the curable composition. On a weight basis, the effective amount of crosslinking agent or catalyst is typically below about 10 parts per hundred parts of the curable composition, more typically below about 5 parts per hundred parts of the curable composition, although higher and lower amounts may also be used.

Crosslinking agents and catalysts can include those known in the art including: peroxides, triazine forming curing agent, benzimidazole forming curing agent, benzoxazole forming curing agent, adipates, and acetates, organometallic compounds, onium salt compounds, perfluorocarboxylic acid salts, triallyl isocyanurate (TAIC), tri(methyl)allyl isocyanurate (TMAIC), among others. These crosslinking agents and catalysts may be used by themselves or in combination.

In one embodiment, the crosslinking agent may be selected from triazine forming cure networks. Such crosslinking agents include: an organotin compounds (such as propargyl-, triphenyl- and allenyl-, tetraalkyl-, and tertraaryl tin curatives); ammonia generating compounds (e.g., see U.S. Pat. No. 6,281,296); ammonium salts, such as ammonium perfluorooctanoate (e.g., see U.S. Pat. No. 5,565,512); and amidines (e.g., see U. S. Pat. No. 6,846,880); imidates (e.g., see U.S. Pat. No. 6,657,013), metalamine complexes (e.g., see U.S. Pat. No. 6,657,012), and hydrochloric salts (e.g., see U.S. Pat. No. 6,794,457).

Peroxides may also be utilized as crosslinking catalyst. Useful peroxides are those which generate free radicals at curing temperatures. A dialkyl peroxide or a bis(dialkyl peroxide), which decomposes at a temperature above 50° C. is especially preferred. In many cases it is preferred to use a di-tertiarybutyl peroxide having a tertiary carbon atom attached to peroxy oxygen. Peroxides selected may include: 2,5-dimethyl-2,5-di(tertiarybutylperoxy)3-hexyne, and 2,5-dimethyl-2,5-di(tertiarybutylperoxy)hexane, dicumyl peroxide, dibenzoyl peroxide, tertiarybutyl perbenzoate, α,α′-bis(t-butylperoxy-diisopropylbenzene), and di[1,3-dimethyl-3-(t-butylperoxy)-butyl]carbonate. Generally about 1-3 parts of peroxide per 100 parts of perfluoroelastomer is used.

In another embodiment, the fluoroelastomer compositions can be cured using one or more peroxide catalysts along with the ammonia generating catalysts. The catalyst may comprise for example, a first component and a second component wherein the first component is represented by R′C(CF₂R)O⁻Q⁺, where Q⁺ is a non-interfering organophosphonium, organosulfonium, or organoammonium cation; each R independently represents H, halogen, a hydrocarbyl group or a halogenated hydrocarbyl group, wherein at least one carbon atom of the hydrocarbyl group may be further substituted with one or more heteroatoms selected from N, O and S; R′ represents H, a hydrocarbyl group or a halogenated hydrocarbyl group, wherein at least one carbon atom of the hydrocarbyl group may be further substituted with one or more heteroatoms selected from N, O and S; or any two of R or R′ may together form a divalent hydrocarbylene group, wherein at least one carbon atom of the hydrocarbylene group may be further substituted by one or more heteroatoms selected from N, O, and S, and the second component is represented by [N≡CCFR″]_{b}Z, wherein each R″ independently represents F or CF₃; b represents any positive integer; and Z represents a b-valent organic moiety free of interfering groups. See e.g., U.S. Pat. No. 7,294,677. Examples include: a reaction product of CF₃OCF₂CF₂CN and tetrabutylphosphonium 2-(p-toluyl)-1,1,1,3,3,3-hexafluoroisopropoxide; a reaction product of CF₃OCF₂CF₂CN and tetrabutylammonium 2-(p-toluyl)-1,1,1,3,3,3-hexafluoroisopropoxide; and combinations thereof.

A catalyst comprising one or more ammonia-generating compounds may be used to cure the perfluoroelastomer. Ammonia-generating compounds include compounds that are solid or liquid at ambient conditions but that generate ammonia under conditions of cure. Such compounds include, for example, hexamethylene tetraamine (urotropin), dicyan diamid, and metal-containing compounds of the formula: A^{w-}(NH₃)ᵥY^{w-}, where A^{w-}is a metal cation such as Cu²⁺, Co²⁺, Co³⁺, Cu⁺, or Ni²⁺; w is equal to the valence of the metal cation; Y^{w-} is a counterion, typically a halide, sulfate, nitrate, acetate or the like; and v is an integer from 1 to about 7.

Also useful as ammonia-generating compounds are substituted and unsubstituted triazine derivatives such as those of the formula:

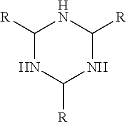

where R is a hydrogen or a substituted or unsubstituted alkyl, aryl, or aralkyl group having from 1 to about 20 carbon atoms. Specific useful triazine derivatives include: hexahydro-1,2,5-s-triazine and acetaldehyde ammonia trimer.

In one embodiment, the crosslinking agent may be selected from the following:

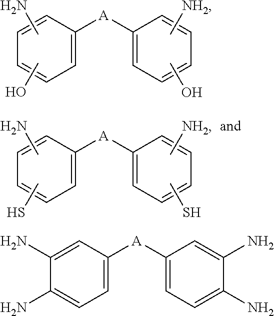

where A is SO₂, O, CO, alkyl of 1-6 carbon atoms, perfluoroalkyl of 1-10 carbon atoms, or a carbon-carbon bond linking the two aromatic rings, such as those disclosed in U.S. Pat. No. 6,114,452.

Useful crosslinking agents may include bis(aminophenols), such as 2,2-bis[3-amino-4-hydroxyphenyl]hexafluoropropane (e.g., see U.S. Pat. Nos. 5,767,204 and 5,700,879); tetraphenyltin; bis(aminothiophenols), such as 4,4′-sulfonylbis(2-aminophenol); aromatic amino compounds; and tetraamines, such as 3,3′ diaminobenzidine; and 3,3′,4,4′-tetraaminobenzophenone.

Bisamidrazone compounds for example, 2,2-bis(4-carboxyphenyl)hexafluoropropane bisamidrazone; and bisamidoximes (e.g., see U.S. Pat. No. 5,621,145) may also be used to crosslink the perfluoroelastomer compound.

In another embodiment, crosslinking catalysts (or precursors thereof) of the following formula may be used:

{R(A)ₙ}⁽⁻ⁿ⁾{QR′ₖ⁽⁺⁾}ₙ

wherein R is a C₁-C₂₀ alkyl or alkenyl, C₃-C₂₀ cycloalkyl or cycloalkenyl, or C₆-C₂₀ aryl or aralkyl, which may be nonfluorinated, partially fluorinated, or perfluorinated, {R(A)ₙ}⁽⁻ⁿ⁾ is an acid anion or an acid derivative anion, n is the number of A groups in the anion, Q is phosphorous, sulfur, nitrogen, arsenic, or antimony, each R′ is, independently, hydrogen or a substituted or unsubstituted C₁-C₂₀ alkyl, aryl, aralkyl, or alkenyl group, provided that when Q is nitrogen and the only fluoropolymer in the composition consists essentially of a terpolymer of tetrafluoroethylene, a perfluorovinylether, and a perfluorovinylether cure site monomer comprising a nitrile group not every R′ is H, and k is one greater than the valence of Q. (See, e.g., U.S. Pat. No. 6,890,995). An example includes bistetrabutylphosphonium perfluoroadipate.

In another embodiment, the crosslinking catalyst may be represented by the following formula:

{RA}⁽⁻⁾{QR′ₖ}⁽⁺⁾

wherein R is hydrogen or an alkyl or alkenyl having from 1 to 20 carbon atoms, cycloalkyl or cycloalkenyl having from 3 to 20 carbon atoms, or aryl or alkaryl having from 6 to 20 carbon atoms. R can contain at least one heteroatom, i.e., a non-carbon atom such as O, P, S, or N. R can also be substituted, such as where one or more hydrogen atoms in the group is replaced with Cl, Br, or I. A is an acid anion or an acid derivative anion, e.g., A can be COO, SO₃, SO₂, SO₂NH, PO₃, CH₂OPO₃, (CH₂O)₂PO₂, C₆H₄O, OSO₃, O (in the cases where R is hydrogen, aryl, or alkylaryl),

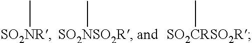

R′ is defined as R (above), and a particular selection for R′ may be the same or different from the R attached to A, and one or more A groups may be attached to R; Q is phosphorous (P), sulfur (S), nitrogen (N), arsenic (As), or antimony (Sb), and k is the valence of Q. (See e.g., U.S. Pat. No. 6,844,388). Examples may include: tetrabutyl phosphonium acetate and tetrabutyl phosphonium benzoate.

Depending on the cure site components present, it is also possible to use a dual cure system. For example, perfluoroelastomers having copolymerized units of nitrile-containing cure site monomers can be cured using a curing agent comprising a mixture of a peroxide in combination with organotin curative and a co-agent.

A co-agent (some times referred to as a co-curative) may be composed of a poly unsaturated compound which is capable of cooperating with the peroxide to provide a useful cure. These co-agents can be added in an amount equal to 0.1 and 10 phr (parts per hundred rubber), or even between 1 and 5 phr. The co-agent may be one or more of the following compounds: triallyl cyanurate; triallyl isocyanurate; tri(methylallyl)isocyanurate; tris(diallylamine)-s-triazine; triallyl phosphate; N,N-diallyl acrylamide; hexaallyl phosphoramide; N,N,N′,N′-tetraallylmalonamide; trivinyl isocyanurate; 2,4,6-trivinyl methyltrisiloxane; and tri(5-norbornene-2-methylene)cyanurate. Particularly useful is triallyl isocyanurate.

Other useful co-agents include the bis-olefins. See e.g., U.S. Pat. Nos. 5,585,449 and 5,902,857.

Organometallic compounds of arsenic, antimony and tin also can be used, for example as described in U.S. Pat. Nos. 4,281,092 and 5,554,680. Particular examples include allyl-, propargyl-, triphenyl-allenyl-, and tetraphenyltin and triphenyltin hydroxide.

In the present disclosure, the multilayered article comprises a primer layer intimately contacting a substrate and a perfluoroelastomer layer. In one embodiment, the multilayered article is prepared by the process disclosed below.

The primer composition is applied to a substrate. As used herein, the term “substrate” means any material suitable for bonding to perfluoroelastomers. Substrates include, for example, various metals (such as for example, aluminum or stainless steel), polymers (such as non-fluorinated and fluorinated, plastics and elastomers), carbon fibers, ceramics (such as glass) and combinations thereof In one embodiment, the polymer substrates include polymers that are stable up to at least 150° C., 175° C., 200° C., 250° C., 300° C. or even 350° C. and include for example, perfluorinated and partially fluorinated polymers, polyimides, etc. The primer composition may be applied to the substrate by techniques known in the art, including for example, dipping, spray coating, pouring, etc.

The coated substrate is then contacted with a perfluoroelastomer compound. The compounded perfluoroelastomer may be in the form of a film, crumb, cord, preform, or powder.

The perfluoroelastomer compound-covered substrate (perfluoroelastomer compound/primer/substrate) is then heated to at least 100° C., 130° C., 140° C., 150° C., 160° C., 180° C., or even 200° C.; at most 150° C., 160° C., 180° C., 200° C., 220° C., 250° C., or even 275° C., to cure the perfluoroelastomer compound. The perfluoroelastomer compound-covered substrate may be heated in a mold to form a cured and bonded perfluoroelastomer article. The heating of the perfluoroelastomer compound-covered substrate cures the perfluoroelastomer and the epoxide resin and bonds the layers together to form a bonded multilayered article.

Post-curing may be done to further cure the article. In one embodiment, the cured and bonded perfluoroelastomer article may be post cured and stay bonded to the substrate at a temperature of at least 150° C., 175° C., 200° C., or even 200° C.; at most 250° C., 275° C., 300° C., 325° C., 350° C., or even 375° C.

The primer composition of the present disclosure between the perfluoroelastomer compositions and other substrates, when exposed to elevated temperatures, such as for example temperatures of at least 200° C., 215° C., 230° C., 250° C., 275° C., or even 300° C., maintains adhesive integrity.

### EXAMPLES

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

Table of Materials

| Acronym | Description |
|---|---|
| PFE131TZ | An uncured nitrile containing perfluoroelastomer commercially |
| | available from Dyneon LLC, Oakdale, MN |
| PFE90Z | An uncured bromine containing perfluoroelastomer commercially |
| | available from Dyneon LLC, Oakdale, MN |
| PFE 01C | Additive available from by Dyneon LLC., Oakdale, MN. |
| PFE 02C | Additive available from by Dyneon LLC., Oakdale, MN. |
| MEK | methyl ethyl ketone |
| DMF | dimethyl formamide |
| EPOXY1 | 1.5 parts by weight EPON 828, 1.0 part by weight EPON 1004F, 2.5 |
| | parts by weight EPON SU2.5 all separately commercially available |
| | from Hexion Specialty Chemicals, Columbus, OH. |
| ARALDITE | A creosol Novolak epoxide resin commercially available from |
| ECN 1280 | Huntsman, The Woodlands, TX. Functionality of 5.1 and epoxy |
| | equivalent weight of 212-233 g/eq (gram/equivalents). |
| EPON 828 | A difunctional bisphenol A/epichlorohydrin derived liquid epoxide |
| | resin with epoxy equivalent weight of 185-192 g/eq available from |
| | Hexion Specialty Chemicals, Columbus, OH. |
| EPON | A solid epoxide resin derived from bisphenol A and epichlorohydrin |
| 1004F | with an average of 4.5-5.0 hydroxyl groups per molecule plus the |
| | terminal epoxy groups. Epoxy equivalent weight of 800-950 g/eq. |
| | Available from Hexion Specialty Chemicals, Columbus, OH. |
| EPON | A Novolak bisphenol A epoxide resin with epoxy equivalent weight of |
| SU2.5 | 187-207 g/eq and a functionality of 2.5, available from Hexion |
| | Specialty Chemicals, Columbus, OH. |
| EPON 1031 | An epichlorohydrin/tetraphenylol ethane epoxide resin with epoxy |
| | equivalent weight of 195-230 g/equivalent and a functionality of |
| | greater than 3, available from Hexion Specialty Chemicals, Columbus, |
| | OH. |
| DEN 438 | A semi-solid reaction product of epichlorohydrin and phenol- |
| | formaldehyde with equivalent weight of 176-181 g/equilvalent and a |
| | functionality of 3.6, commercially available from Dow Chemical, |
| | Midland, MI. |
| HPT 1079 | 9,9 bis-2,3 epoxypropylphenyl]-fluorene polymers with a |
| | functionality of 2 available from Hexion Specialty Chemicals, |
| | Columbus, OH. |
| CHEMLOK | 3-aminopropyltriethoxysilane, vinyltrimethoxysilane and |
| 5150 | benzyltriphenylphosphonium chloride. Available from Lord Corp., |
| | Cary, NC. |
| CUR1 | 0.053 g isophthalyl dihydrazide (available from Sigma Aldrich, St. |
| | Louis, MO) plus 0.08 g dicyandiamide (available under the trade |
| | designation “AMICURE CG 1400” from Air Products and Chemicals, |
| | Allentown, PA) plus 0.053 g EPIKURE 3502(available from Hexion |
| | Specialty Chemicals, Columbus, OH) |
| CUR2 | 4,4′-aminophenyl disulfide available from Aldrich, Milwaukee, WI |
| CUR3 | Guanidine carbonate (H₂NC(═NH)(NH₂)•2H₂CO₃ available from |
| | Aldrich, Milwaukee, WI |
| CUR4 | Thiourea available from Aldrich, Milwaukee, WI |
| CUR5 | Dicyanamide (2-cyanoguanidine) (available from Air Products and |
| | Chemicals, Allentown, PA in MEK) |
| CUR6 | 2 wt % solution of ketimine of ethylenediamine and |
| | methylisobutylketone available under the trade designation |
| | “EPIKURE 3502” from Hexion Specialty Chemicals, Columbus, OH). |
| CUR7 | Mixture of 25.0 wt % of a dicyclopendadiene-based polyepoxide resin, |
| | having an epoxide equivalent weight of from 245 to 265 g/equivalent, |
| | available under the trade designation “TACTIX 756” resin from |
| | Huntsman Advanced Materials Americas, Inc. Brewster, NY); 4.04 wt % |
| | dicyandiamide (1-cyanoguanidine) available under the trade |
| | designation “AMICURE CG-1400” from Air Products and Chemicals, |
| | Inc. Allentown, PA; 4.73 wt % isophthalyldihydrazide, available from |
| | Sigma Aldrich, St. Louis, MO; 15.0 wt % core/shell impact modifier |
| | sold under the trade designation “EXL-2691A” by Rohm and Haas, |
| | Philadelphia, PA; and 3 wt % of a powdered polysulfone |
| | thermoplastic polymer sold under the trade designation “UDEL |
| | P1800” by Solvay Advanced Polymers, LLC. Alpharetta, GA. |
| Peroxide | “VAROX DBPH-50” from R. T. Vanderbilt, Norwalk, CT) |
| TAIC | “TAIC DLC-A” commercially available from Natrochem Inc. |
| | Savannah, GA. |
| STATEX | N-550 FEF carbon black available from Columbian Chemicals, Brazil. |
| AEROSIL | Hydrophobic silica available from Evonik Industries, Mobile, AL. |
| R-972 | |

### Example 1

0.186 grams of a curative (CURL) was dissolved in 10 grams MEK. One gram of ARALDITE ECN 1280 was dissolved in 9 grams MEK. The epoxy in solvent and curative in solvent were mixed 1:1 to produce the primer composition.

94 parts by weight of PFE 131T Z was compounded on a two roll mill with 10 parts by weight ASTM designated N-990 MT carbon black (manufactured by Cancarb, Alberta, Canada), 8 parts by weight STATEX, 1.5 parts by weight of AEROSIL R-972, 6 parts by weight of PFE 01C and 2.5 parts by weight of PFE 02C.

The primer composition was tested for adhesion according to ASTM D-4896-01 with the following modifications. Aluminum (6061 type) coupons (2.54 cm×6.35 cm×0.15 cm) (obtained from Loftech Prototype Manufacturing, LLC., St. Paul, Minn.) were grit blasted with 60 grit aluminum oxide, rinsed in cold water, cleaned with an aluminum cleaner (available under the trade designation “Oakite Aluminum Cleaner 164” from Oakite Products Inc., Berkeley Heights, N.J.), deoxidized with a product available under the trade designation “Oakite Deoxidizer LNC”) from Oakite Products Inc., Berkeley Heights, N.J., rinsed in cold water and air dried. Three drops of the curatives were applied to one 2.54 cm×1.27 cm end area of each of two grit blasted and cleaned aluminum coupons and allowed to dry.

The milled compounded uncured perfluoroelastomer was cut to about a 2.54 cm×1.27 cm film (about 1.3 grams) and laid over about a 2.54 cm×1.27 cm end section of one of the primed and dried aluminum coupons. The perfluoroelastomer was then molded to the primed aluminum coupon for 10 minutes at 177° C. (350° F.). Adhesion testing according to ASTM D-4896-01 was performed on the molded coupons immediately after application of the perfluoroelastomer. Adhesion testing according to ASTM D-4896-01 was also performed on the molded coupons after 16 hours of aging at 200° C. (i.e., post-curing) and 16 hours of aging at 232° C. (i.e., post curing). Results for all three adhesion tests are summarized in Table 1.

### Examples 2-7

The primer compositions were made and adhesion testes were performed as in Example 1 but using the materials shown in for Examples 2-7 in Table 1. Adhesion results are also summarized in Table 1.

### Examples 8-11

The primer compositions were made following Example 2 in U.S. Publ. No. 20060182949 (Salnikov et al.) and is described in the Table of Materials as EPDXY1 and CUR7. The same primer composition was used in all four of these examples, but the solvent was varied. The primer composition was used at 5% by weight in all solvents except Example 9, which included 20% by weight of primer composition. Adhesion tests were performed as in Example 1 and results are summarized in Table 1.

### Example 12

The primer composition and perfluoroelastomer used was identical to that of Example 1. However, instead of using aluminum coupons the substrate was a carbon fiber composite (available under the trade designation “RIGID CARBON FIBER BARS”, Part Number 8194K12 from McMaster-Carr Supply Co., Elmhurst, Ill.). The composite had the same dimensions as the aluminum coupons used in Example 1. The adhesion test was performed as in Example 1 and results are summarized in Table 2.

### Example 13

0.186 grams of a curative (CURL) was dissolved in 10 grams MEK. One gram of ARALDITE ECN 1280 was dissolved in 9 grams MEK. The epoxy in solvent and curative in solvent were mixed to produce the primer composition.

97.6 parts by weight of PFE 131T Z was compounded on a two roll mill with 10 parts by weight of STATEX, 1.5 parts by weight of AEROSIL R-972, 3 parts by weight of PFE 01C, 1 part of tetraallylsilane (obtained from 3M ESPE AG), 0.5 parts of hydrotalcite, DHT-2A (obtained from Kisuma Chemicals, Japan), 1.5 parts of TALC, and 1 part of peroxide (obtained from R.T. Vanderbilt, Norwalk, Conn.).

Adhesion testing was performed as in Example 1 and results are summarized in Table 2.

### Example 14

The primer composition consisted of 10 grams of 10% EPOXY1 by weight in a 1.7: 1.0 mixture of MIBK:MEK and 1 gram of 10% CUR2 by weight in methanol. Adhesion testing was performed as in Example 1 and results are summarized in Table 2.

### Example 15

The primer composition consisted of 5 grams of 10 wt % ARALDITE ECN 1280 in MEK and 1 gram of 10 wt % CUR3 in MEK. Adhesion testing was performed as in Example 1 and results are summarized in Table 2.

### Example 16

The primer composition consisted of 5 grams of 10 wt % ARALDITE ECN 1280 in MEK and 1 gram of 10 wt % CUR4 in MEK. Adhesion testing was performed as in Example 1 and results are summarized in Table 2.

### Example 17

The primer composition consisted of 5 grams of 10 wt % ARALDITE ECN 1280 in MEK and 1 gram of 2 wt % CURS in MEK. Adhesion testing was performed as in Example 1 and results are summarized in Table 2.

### Example 18

The primer composition consisted of 5 grams of 10 wt % ARALDITE ECN 1280 in MEK and 1 gram of CURE. Adhesion testing was performed as in Example 1 and results are summarized in Table 2.

### Example 19

0.186 grams of a curative (CURL) was dissolved in 10 grams MEK. One gram ARALDITE ECN 1280 was dissolved in 9 grams MEK. The epoxy in solvent and curative in solvent were mixed 1:1 to produce the primer composition.

100 parts by weight of PFE 90 Z was compounded on a two roll mill with 15 parts by weight ASTM designated N-990 MT carbon black (obtained under the trade name “THERMAX N990” manufactured by Cancarb, Alberta, Canada), 5 parts by weight of zinc oxide (USP #1 grade obtained from Horsehead Corp., Pittsburgh, Pa.), 2.5 parts of TAIC, and 1.5 part of PEROXIDE. Adhesion testing was performed as in Example 1 and results are summarized in Table 2.

### Example 20

0.186 grams of a curative (CURL) was dissolved in 10 grams MEK. One gram of ARALDITE ECN 1280 was dissolved in 9 grams MEK. The epoxy in solvent and curative in solvent were mixed to produce the primer composition.

100 parts by weight of PFE 131T Z was compounded on a two roll mill with 10 parts by weight ASTM designated N-990 MT carbon black, 8 parts by weight of STATEX, 5 parts by weight of zinc oxide USP #1 grade (obtained from Horsehead Corp., Pittsburgh, Pa.), 3.5 parts of TRIC, and 1.2 parts of PEROXIDE.

Adhesion testing was performed as in Example 1 and results are summarized in Table 2.

### Example 21

0.186 grams of a curative (CURL) was dissolved in 10 grams MEK. One gram of ARALDITE ECN 1280 was dissolved in 9 grams MEK. The epoxy in solvent and curative in solvent were mixed 1:1 to produce the primer composition.

100 parts by weight of PFE 131T Z was compounded on a two roll mill with 10 parts by weight ASTM designated N-990 MT, 8 parts by weight of STATEX, 3.5 parts of TALC, and 1.2 parts of PEROXIDE.

Adhesion testing was performed as in Example 1 and results are summarized in Table 2.

### Examples 22-23

The primer compositions were made and adhesion tests were performed as in Example 1 but using carbon steel and stainless steel coupons respectively as the substrates instead of aluminum. Adhesion results are also shown in Table 2.

### Comparative Example 1

The primer composition was identical to that of Example 1 but without any epoxide resin. Adhesion testing was performed as in Example 1 and results are summarized in Table 1.

### Comparative Example 2

The primer composition consisted of 1.0 gram of EPDXY1 dissolved in 9.0 grams MEK with no added curatives. Adhesion testing was performed as in Example 1 and results are summarized in Table 1.

### Comparative Example 3

The primer composition consisted of CHEMLOK 5150, a silane based resin. This material contains no epoxy resin, but is used for bonding metal to partially fluorinated elastomers. The primer composition was dissolved in 50 wt % methanol. Adhesion testing was performed as in Example 1 and results are summarized in Table 1.

TABLE 1
Epoxide Resin and Solvent Variations

| | | | | Initial | | Adhesion | Adhesion |
|---|---|---|---|---|---|---|---|
| | | | | Adhesion, | | after 16 hrs | after 16 hrs |
| | Epoxide | | | PSI | | at 200° C., | at 232° C., |
| Ex | Resin | Curative | Solvent | (kPa)† | | PSI (kPa) | PSI (kPa) |
| CE1 | NONE | CUR1 | MEK | 82 | (565) | ND¹ | ND¹ |
| CE2 | EPOXY1 | NONE | MEK | 0 | | ND¹ | ND¹ |
| CE3 | Chemlok | NONE | methanol | 162 | (1116) | 297 (2046) | ND¹ |
| | 5150* | | | | | | |
| 1 | ARALDITE | CUR1 | MEK | 1222 | (8420) | 1294 (8916) | 944 (6504) |
| | ECN 1280 | | | | | | |
| 2 | D.E.N. 438 | CUR1 | MEK | 1092 | (7524) | 835 (5753) | 485 (3342) |
| 3 | HPT 1079 | CUR1 | MEK | 1011 | (6966) | 535 (3686) | 576 (3969) |
| 4 | EPON 1031 | CUR1 | MEK | 662 | (4561) | 681 (4692) | 498 (3431) |
| 5 | EPON 828 | CUR1 | MEK | 880 | (6063) | 378 (2604) | 418 (2880) |
| 6 | EPON 1004F | CUR1 | MEK | 956 | (6587) | 430 (2963) | 410 (2825) |
| 7 | EPON SU2.5 | CUR1 | MEK | 1071 | (7379) | 803 (5533) | 408 (2811) |
| 8 | EPOXY1 | CUR7 | MEK | 904 | (6229) | ND¹ | ND¹ |
| 9 | EPOXY1 | CUR7 | Hexafluoro | 1056 | (7276) | ND¹ | ND¹ |
| | | | isopropanol | | | | |
| 10 | EPOXY1 | CUR7 | DMF | 556 | (3831) | ND¹ | ND¹ |
| 11 | EPOXY1 | CUR7 | HC₄F₈CH₂OH | 94 | (648) | ND¹ | ND¹ |

†PSI = pounds per square inch, kPa = kilo Pascals
*Chemlok 5150 is not an epoxide resin
¹= not done

TABLE 2
Curative and Substrate Variations

| | | | | Initial | | Adhesion | | Adhesion |
|---|---|---|---|---|---|---|---|---|
| | | | | Adhesion, | | after 16 hrs | | after 16 hrs |
| | | | | PSI | | at 200° C., | | at 232° C. |
| Ex | Epoxy | Curative | Solvent | (kPa) | | PSI (kPa) | | PSI (kPa) |
| 12² | ARALDITE | CUR1 | MEK | 868 | (5987) | ND¹ | | ND¹ |
| | ECN 1280 | | | | | | | |
| 13 | ARALDITE | CUR1 | MEK | 1670 | (11510) | 934 | (6435) | 264 (1819) |
| | ECN 1280 | | | | | | | |
| 14 | EPOXY 1 | CUR2 | MEK/ | 256 | (1764) | 325 | (2239) | 345 (2377) |
| | | | methanol | | | | | |
| 15 | ARALDITE | CUR3 | MEK | 730 | (5030) | 494 | (3404) | 322 (2219) |
| | ECN 1280 | | | | | | | |
| 16 | ARALDITE | CUR4 | MEK/ | 860 | (5925) | 1234 | (8502) | 639 (4403) |
| | ECN 1280 | | methanol | | | | | |
| 17 | ARALDITE | CUR5 | MEK | 1178 | (8116) | 994 | (6849) | 677 (4665) |
| | ECN 1280 | | | | | | | |
| 18 | ARALDITE | CUR6 | MEK | 821 | (5657) | 265 | (1826) | ND¹ |
| | ECN 1280 | | | | | | | |
| 19³ | ARALDITE | CUR1 | MEK | 1234 | (8502) | 831 | (5726) | 539 (3714) |
| | ECN 1280 | | | | | | | |
| 20 | ARALDITE | CUR1 | MEK | 1550 | (10680) | 1393 | (9598) | 744 (5126) |
| | ECN 1280 | | | | | | | |
| 21 | ARALDITE | CUR1 | MEK | 1075 | (7407) | 1205 | (8302) | 710 (4892) |
| | ECN 1280 | | | | | | | |
| 22⁴ | ARALDITE | CUR1 | MEK | 857 | (5905) | ND¹ | | ND¹ |
| | ECN 1280 | | | | | | | |
| 23⁵ | ARALDITE | CUR1 | MEK | 921 | (6346) | 1024 | (7055) | ND¹ |
| | ECN 1280 | | | | | | | |

¹= not done
²= bonded to carbon fiber composite instead of aluminum; aluminum used in all other examples
³= perfluoroelastomer used was PFE90XZ; PFE131TZ used in all other examples
⁴= bonded to type 1018 mild steel (carbon steel) coupons from Classic Manufacturing Co., Oakdale, MN: aluminum used in all other samples unless otherwise noted.
⁵= bonded to type 304 stainless steel coupons from Classic Manufacturing Co., Oakdale, MN; aluminum used in all other examples unless otherwise noted.

1. A primer composition comprising a curative, a solvent and an epoxide resin; wherein the curative is capable of reacting with the epoxide resin, and wherein the solvent is capable of dissolving the epoxide resin; and further wherein;
(a) the curative is capable of curing a perfluoroelastomer compound having at least one cure site and a crosslinking agent or catalyst; or
(b) when the curative is not capable of curing the perfluoroelastomer compound, the perfluoroelastomer comprises a crosslinking agent or catalyst capable of curing the epoxide resin.

2. The composition of claim 1 wherein the epoxide resin contains a phenolic moiety.

3. The composition of claim 1 wherein the epoxide resin has a functionality greater than 2.

4. The composition of claim 1 wherein the curative is selected from a isophthalyl dihydrazide, a dicyandiamide, a 4,4-aminophenyl disulfide, a guanidine carbonate, a thiourea, a ketimine comprising a condensation product of ethylenediamine or a 3-aminopropyl triethoxysilane and methylisobutylketone, a polyaromatic polyamine, an aminophenol-containing compound, o-bis aminophenol AF, and combinations thereof.

5. The composition of claim 1 wherein the solvent is selected from a ketone, an alcohol, a sulfone, a sulfoxide, an ether, a glycol ether, an amide, and combinations thereof.

6. The composition of claim 5 wherein the solvent is a fluorine-containing alcohol.

7. The composition of claim 1 wherein the crosslinking agent or catalyst is selected from an ammonia generating compound, an organometallic compound, an onium salt compound, a perfluorocarboxylic acid salt, a peroxide, a triallyl isocyanurate, a tri(methyl)allyl isocyanurate, and combinations thereof.

8. The composition of claim 1 wherein the cure site is selected from a nitrogen, a bromine, a chlorine, or an iodine containing cure site, an olefin, and combinations thereof.

9. The composition of claim 8 wherein the nitrogen containing cure site is a nitrile containing cure site.

10. The composition of claim 1 wherein the epoxide resin is selected from creosol Novolak, epichlorohydrin/tetraphenylol ethane, bisphenol A/epichlorohydrin, Novolak/bisphenol A, epichlorohydrin/phenol-formaldehyde, 9,9-bis-2,3-epoxypropylphenyl fluorene, bisphenol AF/epichlorohydrin, Novolak/bisphenol AF, and combinations thereof.

11. A process of bonding a perfluoroelastomer compound to a substrate comprising:
(a) coating the substrate with a primer composition comprising a curative, a solvent and an epoxide resin; wherein the curative is capable of curing the epoxide resin, and wherein the solvent is capable of dissolving the epoxide resin; and further wherein;
(i) the curative is capable of curing the perfluoroelastomer compound having at least one cure site and a crosslinking agent or catalyst; or
(ii) when the curative is not capable of curing the perfluoroelastomer compound, the perfluoroelastomer comprises a crosslinking agent or catalyst capable of curing the epoxide resin;
(b) covering the coated substrate with the perfluoroelastomer compound;
(d) heating the perfluroelastomer compound covered substrate to at least 150° C. in a mold to form a cured and bonded perfluoroelastomer article.

12. The process of claim 10 further comprising post curing the cured and bonded perfluoroelastomer article at a temperature ranging from 175° C. to 300° C.

13. A multilayer article comprising a substrate, a primer layer and a curable perfluoroelastomer layer; wherein the primer layer is derived from a composition comprising a curative, a solvent and an epoxide resin; and wherein the curative is capable of curing the epoxide resin, and wherein the solvent is capable of dissolving the epoxide resin; and further wherein;
(a) the curative is capable of curing a perfluoroelastomer compound having at least one cure site and a crosslinking agent or catalyst; or
(b) when the curative is not capable of curing the perfluoroelastomer compound, the perfluoroelastomer comprises a crosslinking agent or catalyst capable of curing the epoxide resin.

14. The multilayer article of claim 13 wherein epoxide resin is a phenolic.

15. The multilayer article of claim 13 wherein epoxide resin has a functionality greater than 2.

16. The multilayer article of claim 13 wherein the substrate is selected from a metallic, a polymeric, a carbon fiber, a ceramic, and combinations thereof.

17. The multilayer article of claim 13 wherein the curative is selected from from isophthalyl dihydrazide, dicyandiamide, 4,4-aminophenyl disulfide, guanidine carbonate, thiourea, and a ketimine comprising a condensation product of ethylenediamine or a 3-aminopropyl triethoxysilane and methylisobutylketone, o-bis aminophenol AF, and combinations thereof.

18. The multilayer article of claim 13 wherein the solvent is selected from a ketone, an alcohol, a sulfone, a sulfoxide, an ether, a glycol ether, an amide, and combinations thereof.

19. The multilayer article of claim 13 wherein the epoxide resin is selected from creosol Novolak, epichlorohydrin/tetraphenylol ethane, bisphenol A/epichlorohydrin, Novolak/bisphenol A, epichlorohydrin/phenol-formaldehyde, 9,9-bis-2,3-epoxypropylphenyl fluorine, epoxypropylphenyl fluorene, bisphenol AF/epichlorohydrin, Novolak/bisphenol AF, and combinations thereof.

20. The multilayer article of claim 13 wherein the crosslinking agent or catalyst is selected from an ammonia generating compound, an organometallic compound, an onium salt compound, a perfluorocarboxylic acid salt, a peroxide, a triallyl isocyanurate, a tri(methyl) allyl isocyanurate, and combinations thereof.

21. The primer composition of claim 1 wherein the solvent is capable of dissolving the curative.
